(19) United States
(12) Patent Application Publication
(10) Pub. No.: US 2014/0086454 A1
(43) Pub. Date: Mar. 27, 2014

(54) ELECTRO-OPTICAL RADAR AUGMENTATION SYSTEM AND METHOD

(71) Applicants: Marc C. Bauer, Goleta, CA (US); Mark J. Lamb, Goleta, CA (US); James W. Rakeman, Brea, CA (US)

(72) Inventors: Marc C. Bauer, Goleta, CA (US); Mark J. Lamb, Goleta, CA (US); James W. Rakeman, Brea, CA (US)

(21) Appl. No.: 13/625,365

(22) Filed: Sep. 24, 2012

(51) Int. Cl. G06K 9/00; G01J 5/32

(52) U.S. Cl. 382/107; 250/339.14; 382/100

(57) ABSTRACT

Presently disclosed are concepts, systems, and techniques directed to augmenting a radar with a plurality of electro-optical (E/O) sensors. The E/O sensors operate in two or more IR bands and have variable range of sensitivities. The outputs from the E/O sensors are correlated to determine and confirm a launch or firing event of a missile, mortar, or similar projectile weapon. From this correlation, time and location of launch/firing may be determined and the radar system alerted to the new threat.

### BACKGROUND

A typical ground-based radar system for detecting missile or mortar launches includes, among other things, a radar transmitter, receiver, and processing electronics to both control the radar and to interpret return signals. Such radars, when in an active scanning or surveillance mode, radiate or “paint” a relatively large volume of space, looking for events. When an event of interest (such as, for example, the appearance of a rapidly-moving object in the air), the radar typically switches to a staring or small-volume scan mode to obtain more information about the potential target. This type of operation creates gaps in both time and space in the surveillance coverage when the radar is in dwell mode. In addition, since radars cannot see everything at once, there are temporal gaps in coverage due to the scanning radar's motion.

Additionally, ground-based radars have a hard time locating the launch location of small rockets. By the time the ground radar begins to track the rocket, a significant amount of time has elapsed since launch. Another basic problem is ground clutter. Typically, most radars cannot acquire a rocket in flight until it separates from (or rises above) the ground clutter. Complicating this is the fact that some recent battlefield engagements have been in urban areas, creating the need to identify the exact launch location within a few meters.

Prior attempts at using electro-optical (E/O) systems to augment radars have used a single infrared (IR) band. These approaches typically use high frame rates to determine if the alarm is real, in order to reduce false alarms. The dual band approach employed in airborne missile warning systems uses two very close mid-wavelength infrared (MWIR) bands, which produce low sun glint false alarms. Dual-band systems may also be used to discriminate concealed weapons, as in U.S. Patent Application No. US 2008/0144885 by Zucherman, et al. (directed toward detecting dangerous objects on a person using a dual IR band sensor).

A dual-band approach to ground radar augmentation has also been described in, e.g., U.S. Application Patent No. US 2011/0127328 by Warren (directed to a dual IR band radar augmentation system). However, such prior art systems tend to have unacceptably high false alarm rates and are not adaptable to active surveillance radar systems.

The following table illustrates a commonly used IR band sub-division scheme and provides a helpful reference for terms used herein. This table is reproduced from Byrnes, James, Unexploded Ordnance Detection and Mitigation, pp. 21-22, Springer (2009).

| Division Name | Abbreviation | Wavelength | | Characteristics |
|---|---|---|---|---|
| Near-infrared | NIR, IR-A (DIN) | 0.75-1.4 | μm | Defined by the water absorption and |
| | | | | commonly used in fiber optic |
| | | | | telecommunication because of low attenuation |
| | | | | losses in the SiO₂ glass (silica) medium. Image |
| | | | | intensifers are sensitive to this area of the |
| | | | | spectrum. Examples include night vision |
| | | | | devices such as night vision goggles. |
| Short- | SWIR, IR-B | 1.4-3 | μm | Water absorption increases significantly at |
| wavelength | (DIN) | | | 1,450 nm. The 1,530 to 1,560 nm range is the |
| infrared | | | | dominant spectral region for long-distance |
| | | | | telecommunications. |
| Mid- | MWIR, IR-C | 3-8 | μm | In guided missile technology the 3-5 μm |
| wavelength | (DIN), Also | | | portion of this band is the atmospheric window |
| infrared | called | | | in which the homing heads of passive IR ‘heat |
| | intermediate | | | seeking’ missiles are designed to work, homing |
| | infrared (IIR) | | | on to the Infrared signature of the target |
| | | | | aircraft, typically the jet engine exhaust plume |
| Long- | LWIR, IR-C | 8-15 | μm | This is the “thermal imaging” region, in which |
| wavelength | (DIN) | | | sensors can obtain a completely passive picture |
| infrared | | | | of the outside world based on thermal |
| | | | | emissions only and requiring no external light |
| | | | | or thermal source such as the sun, moon or |
| | | | | infrared illuminator. Forward-looking infrared |
| | | | | (FLIR) systems use this area of the spectrum. |
| | | | | This region is also called the “thermal |
| | | | | infared.” |
| Far infrared | FIR | 15-1,000 | μm | (See also far-infrared laser). |

### SUMMARY

Unfortunately, there are deficiencies to the above-described conventional approaches. For example, as noted above, ground clutter and false alarms (due to sun glint or other interference) have previously limited the ability of electro-optical (E/O) systems to successfully augment ground-based active surveillance radars.

Embodiments of the presently-described E/O radar augmentation systems and methods may use two or more infrared bands to solve these problems. In one exemplary embodiment, a SWIR band may be employed to detect the launch time and bearing with the greatest sensitivity in direct and non-direct line sight viewing. A second IR sensor operating in the MWIR/LWIR band may be employed to track the rockets after burnout with the maximum range. The MWIR/LWIR band sensor may also be employed to pickup the launch position in direct line of sight. The combination of the two bands gives the maximum range for detection and tracking. The combination also reduces false alarm in the SWIR band without using time domain identification because the second sensor band(s) (e.g., MWIR/LWIR) may be used to confirm the launch detection outputs of the first (SWIR) E/O sensor.

One aspect of the present E/O radar augmentation system is the ability to run both bands at optimum sensitivity allowing target saturation, thus enabling maximum range detection. Previous designs seen in the art have required that the target not saturate the pixels so time domain analysis can be performed. Allowing the pixels to saturate in both bands gives maximum range to detection and tracking, lowering the cost and performance needs of the inventive E/O system.

One embodiment of the invention is directed to an apparatus for augmenting an active surveillance radar with a plurality of electro-optical (E/O) sensors, comprising: a first E/O sensor operating in a first infrared (IR) band having a variable range of sensitivities and an output; at least a second E/O sensor operating in a second IR band having a variable range of sensitivities and an output; a processing unit operably connected to said first E/O sensor and said second E/O sensor, said processing unit configured to: correlate the outputs of said first E/O sensor and the outputs of at least said second E/O sensor; determine a launch event from said correlation; and derive time and location information from said determination; and provide said time and location information to the active surveillance radar, wherein said first E/O sensor and said second E/O sensor are operated at optimum sensitivity to cause target saturation and enable maximum detection range in each said E/O sensor and wherein said second E/O sensor is used at least to confirm the output from said first E/O sensor.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an isometric view of a dual-band electro-optical (E/O) sensor array according to one embodiment of the present invention. FIG. 1A shows an embodiment of the array without a cover. FIG. 1B shows an embodiment of the array with a cover in place.

FIG. 2 is an alternate embodiment of a dual-band E/O sensor array.

FIG. 3 is a system block diagram of a dual-band E/O sensor array according to one embodiment of the present invention.

FIGS. 4A and 4B are a flowchart of a direct-fire detection process according to one embodiment of the present invention.

FIG. 5 is an example of multi-frame sensor output showing expansion of ignition energy over time as seen by two IR sensors configured according to one embodiment of the present invention.

FIG. 6 is an exemplary frame-to-frame delta view of a ballistic projectile in flight as seen by a MWIR sensor configured according to one embodiment of the present invention.

FIGS. 7A and 7B are a flowchart of an indirect-fire detection process according to one embodiment of the present invention.

FIG. 8 is an exemplary non-line-of-sight frame subtraction detection of a launch as seen by a SWIR sensor configured according to one embodiment of the present invention.

FIG. 9 is a block diagram of a representative computer system.

### DETAILED DESCRIPTION

One exemplary embodiment of the present systems and techniques are directed to an apparatus employing two separate IR sensors: a SWIR band camera and a MWIR band camera. These two IR bands produce the best long-range detection and longest range tracking of a target missile or other projectile. Another key benefit of using two bands is lower false alarm rates allowing for maximum sensitivity of the SWIR band.

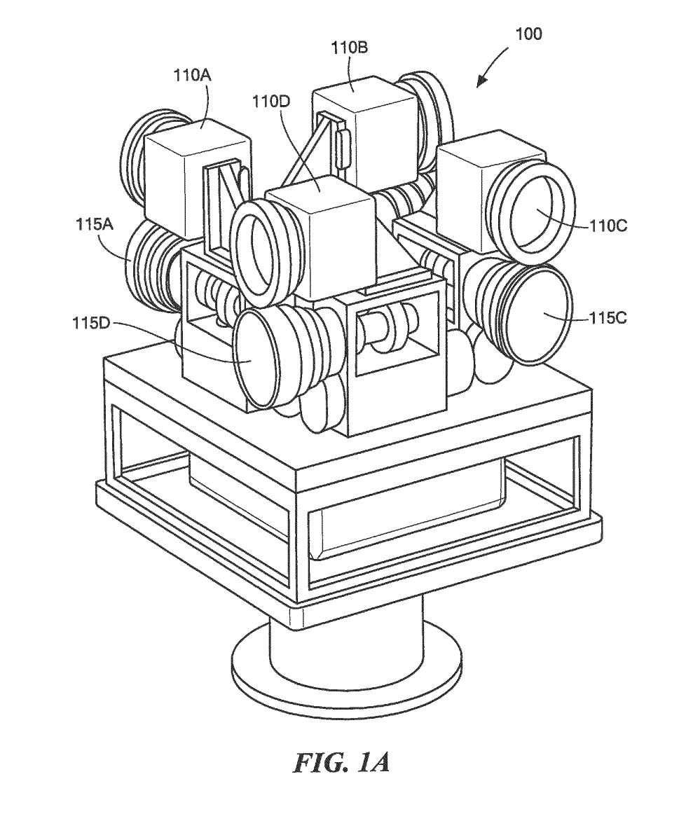

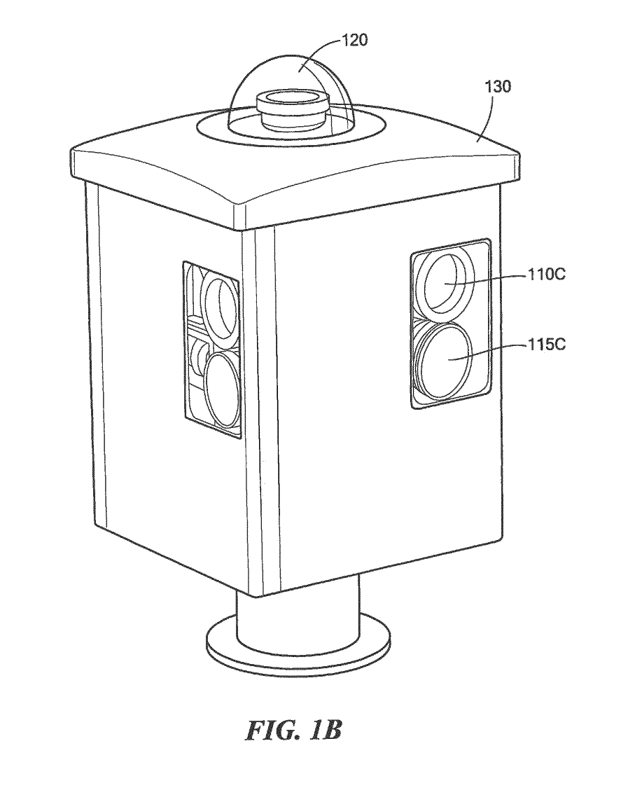

In one embodiment, depicted in FIGS. 1A (with cover removed) and 1B (with cover in place), four two-camera sensor sets (each comprised of SWIR sensors 110 and MWIR sensors 115) may be employed. Each two-camera sensor set covers, in this exemplary embodiment, a 90-degree horizontal field of view (FOV), making 360 degree coverage possible.

In another embodiment, one or more sensor sets may be used to cover approximately 90 degrees horizontal and less than 60 degrees vertical.

The SWIR camera (or sensor, generally) 110 may be a low noise 1280×1024 12 micrometer (μm) pixel size camera. The field of view may be selected to provide, in one embodiment, 100 degrees horizontal and 20-30 degrees vertical (1.36 milliradian [mrad] resolution). One of ordinary skill in the art will recognize that other field of view parameters may also be chosen, without limitation, and that configurations employing more than one sensor may also be used without limitation.

The SWIR sensor 110 may run at a range of speeds, in terms of frames per second (fps); in one exemplary embodiment, it runs at a 90 fps single integration time. Other embodiments may run the camera with a reduced FOV in the vertical dimension in order to speed up the frame rate to 200-400 fps. Various such trade-offs in FOV and frame rate may be made in order to tailor the images produced to a repletion rate and field of coverage appropriate to the number of sensors and the desired mission.

Since lower noise increases the system detection range, in one exemplary embodiment, the SWIR sensor 110 may have a relatively low noise floor consistent with current leading edge SWIR sensor technology. The SWIR sensor 110 may also have a double sample capability, which increases its dynamic range over single sample implementation. Such a SWIR sensor may employ the High Dynamic Range Dual Mode (HDR-DM) CTIA/SFD circuitry described in commonly-owned U.S. Pat. No. 7,492,399, issued Feb. 17, 2009 to Gulbransen et al., and incorporated herein by reference in its entirety.

With both a source follower per detector (SFD) and charge transimpedance amplifier (CTIA) modes of operation, the SWIR sensor 110 can operate with maximum detection range in bright sunlight and in the dark of night. The CTIA mode may be used primarily for night vision. The double integration time allows for maximum sensitivity without the normal image bloom caused by lack of dynamic range. The SFD mode will be used during bright sunlight allowing for maximum well depth of the pixels to handle sunlight and large dynamic range. A variable range of detection sensitivity may also be provided.

The MWIR sensor 115A-D (115B not visible) may be, in some embodiments, an off-the-shelf camera from NOVA Sensors, such as that illustrated in FIG. 1A. In one exemplary embodiment, the format may be 640×512 with a 15 μm pixel size. The field of view may be 95 degrees horizontal and 38-76 degrees vertical (yielding a 2.56 mrad resolution), although other configurations are possible and well-within the skill of one of ordinary skill in the art. The camera sensor may be a cooled InSb focal plane array (FPA) with a frame rate of 60 Hz. This camera may also be operated at higher speeds by reducing the vertical field of view. A variable range of detection sensitivity may also be provided. The frame rate and FOV may also be selected to optimize the detection sensitivity and tracking capability.

Nova Sensors is a trade name of Nova Research, Inc. of Solvang, Calif.

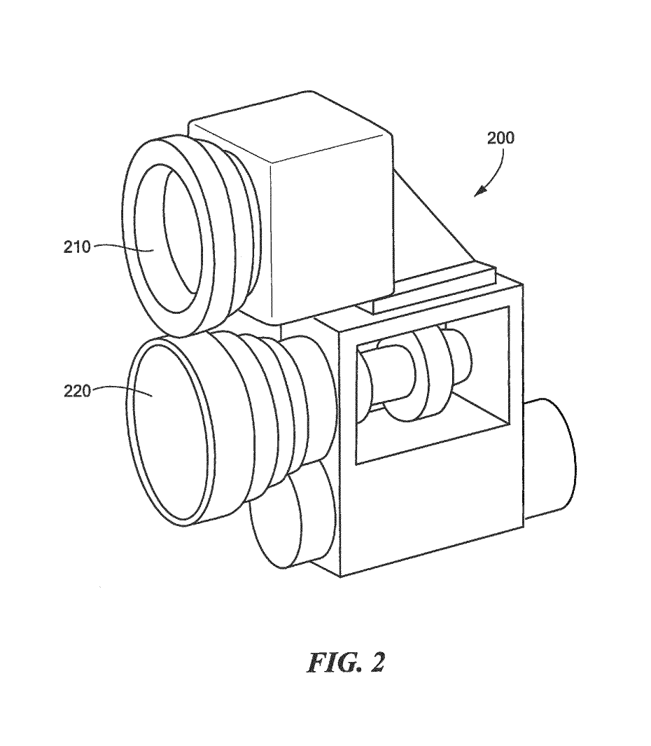

The E/O system housing 130 may be configured for full 360-degree operation. Preferably, housing 130 is water tight, EMI tight, and designed for full military temperature operation (−40 to 71 degrees C.). In one exemplary embodiment, a full 360 degree hemispherical E/O system may contain nine cameras, namely four SWIR, four MWIR, and one LWIR uncooled sensor 120, as shown in FIG. 1B. An alternate embodiment may be mounted in the same housing but using only two cameras, MWIR sensor 210 and MWIR sensor 220, as shown in FIG. 2.

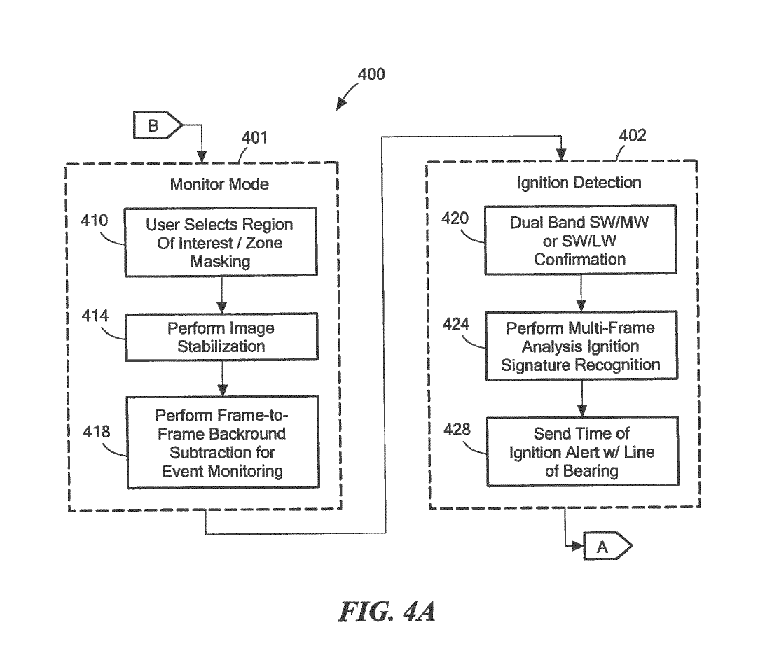

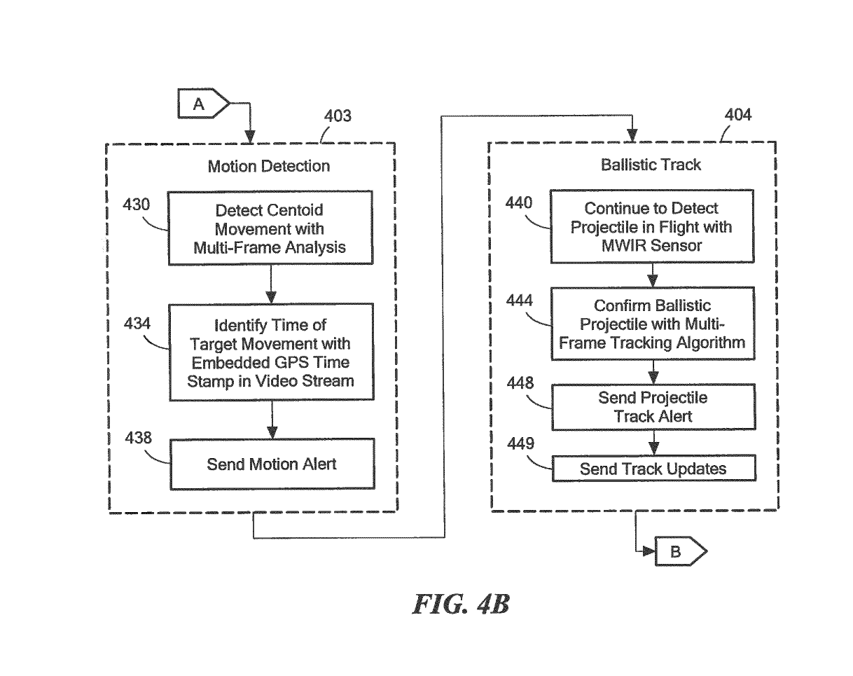

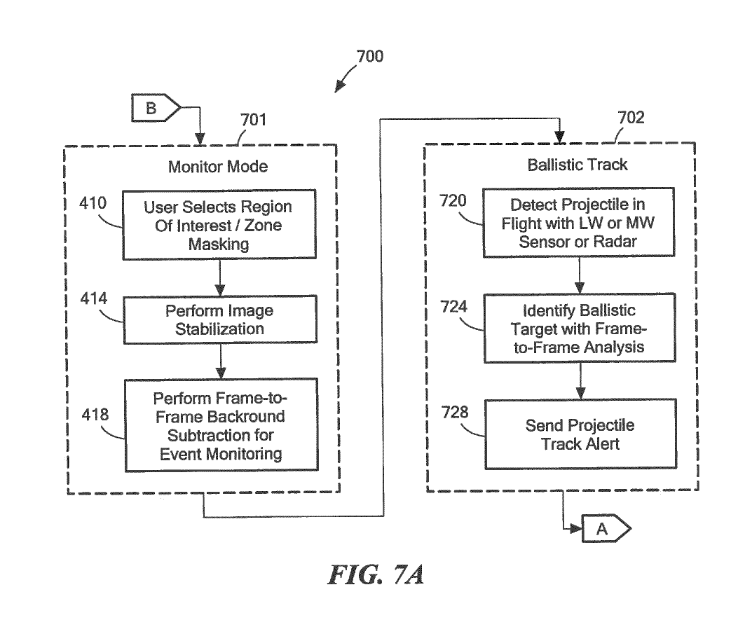

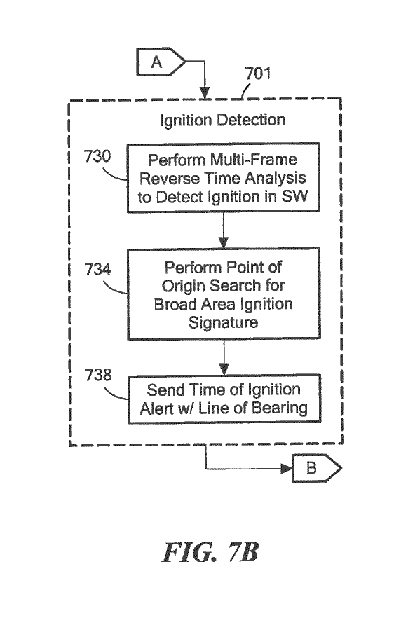

In one exemplary embodiment, there may be four detection modes of the E/O system for direct line of sight surveillance and at least two for non-direct line of sight, as shown in FIGS. 4 and 7, respectively. The combination of SWIR and MWIR alarming on a rocket at the same location will be used as a false alarm rejection method.

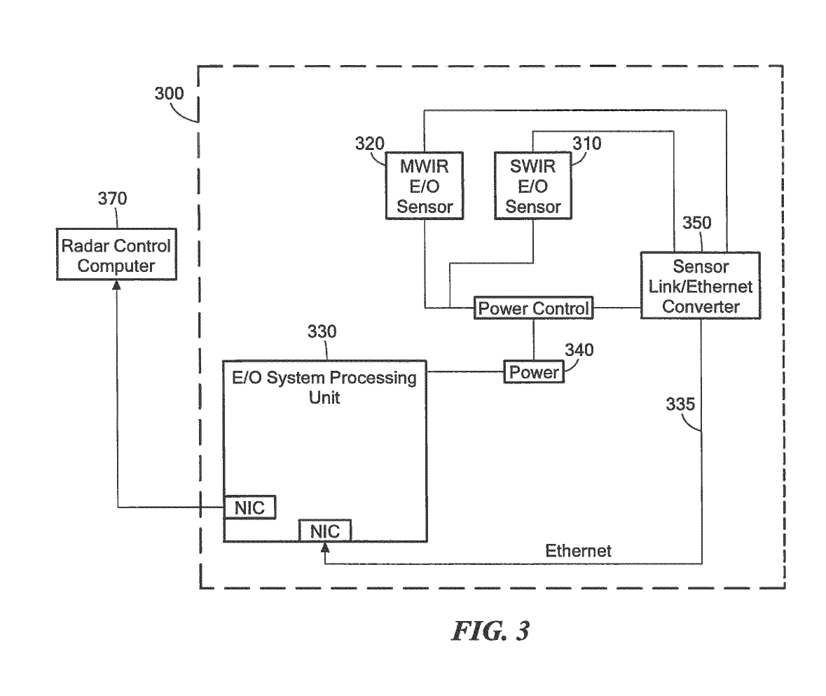

FIG. 3 illustrates a high-level block diagram of an E/O system 300 constructed in accordance with one embodiment of the concepts, systems, and techniques disclosed herein. The E/O system is configured to send a location, time, and track signal over a network connection (such as but not limited to the well-known Ethernet protocols) to the radar control computer 370 when an alarm is generated in both sensor 310 and 320. A phased alert system is employed to provide the earliest warning possible allowing the radar to focus on a region of interest and to minimize the false alarm rate.

For direct fire threats (i.e., where the sensors 310 and 320 have a direct line-of-sight to the launcher), the first warning is a possible launch alert based on the correlation of both SWIR and MWIR detection and corresponding sensor outputs. This alert provides a dual-band confirmation (or correlation) of a high-energy event consistent with a rocket or mortar ignition. The next alert would be confirmation of a moving target in both bands correlated to the ignition event, the result of determining the confirmed ignition event. This event potentially indicates detection of rocket launch or mortar motion leaving the launch tube. The last stage of sensor detection is a MWIR track correlated to the launch event providing confirmation of a ballistic threat and providing an alert to the radar system containing time and location information for the launch event.

For indirect fire threats (non-line-of-sight launch), the MWIR 320 is not expected to see the launch ignition. Since the SWIR camera 310 is very sensitive to many sources of energy, a MWIR track confirmation is needed as a false alarm filter. Upon confirmation of a MWIR track on a ballistic target, the processing unit will search the SWIR data backward in time for indications of the launch ignition. A maximum likelihood method will be used to provide the probable time of ignition for each confirmed MWIR track. The E/O sensor system 300 will then send an alert to the radar computer 370 with the MWIR track information and the SWIR ignition time. The radar may need to estimate the time differential between the ignition time and the motion time as time of motion may not be guaranteed in the non-line of sight condition.

| | SWIR | MWIR | RADAR | Alert | Data | Timing |
|---|---|---|---|---|---|---|
| Direct Line of Sight | | | | | | |
| Detect Launch | X | X | — | Possible | Event No. | 50-100 ms |
| Ignition | | | | Launch | w/ | |
| | | | | Event | Time of | |
| | | | | | Ignition | |
| Detect Launch | X | X | — | Likely | Event No. | Variable |
| Movement | | | | Launch | w/ | |
| | | | | Event | Time of | |
| | | | | | Motion | |
| Early Track on | — | X | — | Probable | Event No. | Variable |
| Projectile | | | | Launch | w/ | |
| | | | | Event | Track Info | |
| Periodic Track | — | X | X | Projectile | Event No. | TBR |
| Updates | | | | Track | w/ | |
| | | | | Update | Track | |
| | | | | | Update | |
| Indirect Line of Sight | | | | | | |
| MWIR Detect | — | X | — | Probable | Event No. | Variable |
| Projectile & Cue | | | | Launch | w/ | |
| SWIR | | | | Event | Track Info | |
| SWIR Search for | X | X | — | Update | Event No. | TBR |
| Time of Ignition | | | | Time of | w/ | |
| | | | | Ignition | Time of | |
| | | | | | Ignition | |

The E/O System may use multiple methods to reduce false alarms including at least two of:

a. Dual band detection employing SWIR and MWIR flash correlation

b. Time domain profile

c. Amplitude of flash intensity

d. Number of pixels of flash

e. Movement of flash over time

f. Location in the images

The false alarm rate is inversely proportional to sensitivity of the E/O system. Simulation has shown that one false alarm per minute is achievable with the proposed E/O system.

The E/O system timing may be obtained by adding a GPS IRIG B data stream into the camera link data stream (not shown). In such a configuration, each frame may contain a time code accurate to one millisecond. The data latency within the sensors may then be used to calculate the absolute time of the image frame within one millisecond. One of ordinary skill in the relevant radar and timing arts will recognize that alternate methods of syncing the radar to the image frame may be employed, without limitation.

Once the system determines an alarm event is valid, a message with the alarm location, time, and or track data may be sent by Ethernet to the radar control computer 370 with a latency of less 50 milliseconds.

The E/O system electronic connections are shown at a high level in FIG. 3. The data from the first E/O sensor 310 (SWIR) and the second E/O sensor 320 (MWIR) may be converted into network-compatible signals, such as but not limited to Ethernet, in converter 350. The network data may then be conveyed to processing unit 330 over fiber optics 335 to ensure that EMI from the radar (not shown) does not corrupt the data. Power 340 may be provided by a single connection to the E/O system from locally-available power, typically 110 v 400 Hz or a 28 volt DC.

In one embodiment, the first E/O sensor may operate in the SWIR (900˜1700 nm) band while the second E/O sensor operates in the MWIR (3.8-5.1 μm) band. Alternatively, the second E/O sensor may operate in the LWIR (8-12 μm) band. Images are saved continuously to accumulate, in one embodiment, five seconds of history. Alternatively, rolling image saves of shorter or longer durations may be used without limitation. The E/O system memory is thus sized according to the rolling image save duration desired. For example, for a SWIR sensor operating at 200 frames per second, five seconds=1000 frames rolling save. For a MWIR or LWIR sensor operating at 60 frames per second, five seconds=300 frames of rolling save.

Although two single-band sensors are described, those skilled in the art will realize that multiple-band sensors, or sensors configured to operate over two or more adjoining IR bands, may be used. Accordingly, the concepts, systems, and techniques described herein are not limited to any particular combination of single-band, sub-band, and/or combined band sensors.

FIGS. 4A and 4B shows an exemplary flow for the direct (line-of-sight) fire detection process 400 from ignition detection mode 401 through ballistic tracking confirmation mode 404. Each box within a mode describes the main tasks performed in the E/O sensor processing unit and alert messages sent to the radar system. As used herein, the term “processing” may comprise the application of existing image processing techniques that look for specific information in each of the different detection modes as well as other processing and communication techniques and algorithms known and used in the relevant arts. Each mode is described in further detail below.

Monitor mode 401 (FIG. 4A) relies on several features for continuous monitoring for direct fire events. Security monitoring features may comprise, for example, zone masking, image stabilization, and target detection via frame-to-frame changes (also referred to herein as frame subtraction). In one exemplary embodiment, processing may be implemented in hardware, firmware, software, or a combination thereof in the E/O system processing unit. In general, the E/O system processing unit first allows the user to select a region of interest, step 410, or alternatively to select a region to be masked out. Next, the image received in the camera sensor is stabilized, step 414. Finally, frame-to-frame background subtraction may be used for continuous event monitoring in step 418. This step looks for saturated video (also referred to herein as target saturation) in the same area of the camera field of view. The imaging camera parameters may be set up such that large signal events such as rocket ignition or explosions result in saturated video pixels. Many motion events such as vehicle headlights, airport lighting, human or animal traffic, will not set off both the SWIR and MWIR/LWIR bands, thus reducing false alarm rates. Monitor mode 401 continues until an ignition event is detected, shown by the transition to Ignition Detection mode 402.

The E/O system processing unit will not go into Ignition Detection mode 402 unless both sensors have targets above a very high detection threshold in the same spatial location, shown as step 420. Here, both sensors (whether SWIR and MWIR, SWIR and LWIR, or SWIR and MWIR/LWIR combined band, without limitation) must show an ignition event to confirm. Dual band sun glint removal algorithms may also be used in this false alarm rejection mode. When both sensors positively identify a spatially correlated high-energy event, processing performs multi-frame analysis, step 424, to confirm the ignition event and sends an alert to the radar control computer containing time of ignition and line of bearing or other location coordinates of the ignition event, step 428.

High-energy events from rocket or mortar launches have patterns that can be recognized by imaging camera systems. Prior art high speed radiometry systems have attempted to identify signatures of rockets, gunfire, sunlight, etc., but these systems require very high frame rates and high dynamic ranges to prevent signal intensity (target) saturation. The concepts, systems, and techniques disclosed herein, by contrast, are capable of recognizing high-energy events consistent with rocket or mortar launch with frame rates achievable with standard (conventional) imaging sensors. Very high-energy events will achieve high threshold levels on both SWIR and MWIR/LWIR sensors, but the present system only needs to run at high enough of a frame rate to determine ignition time and the MWIR/LWIR confirms high-energy events, therefore simplifying the system design and sensor requirements as compared to the prior art.

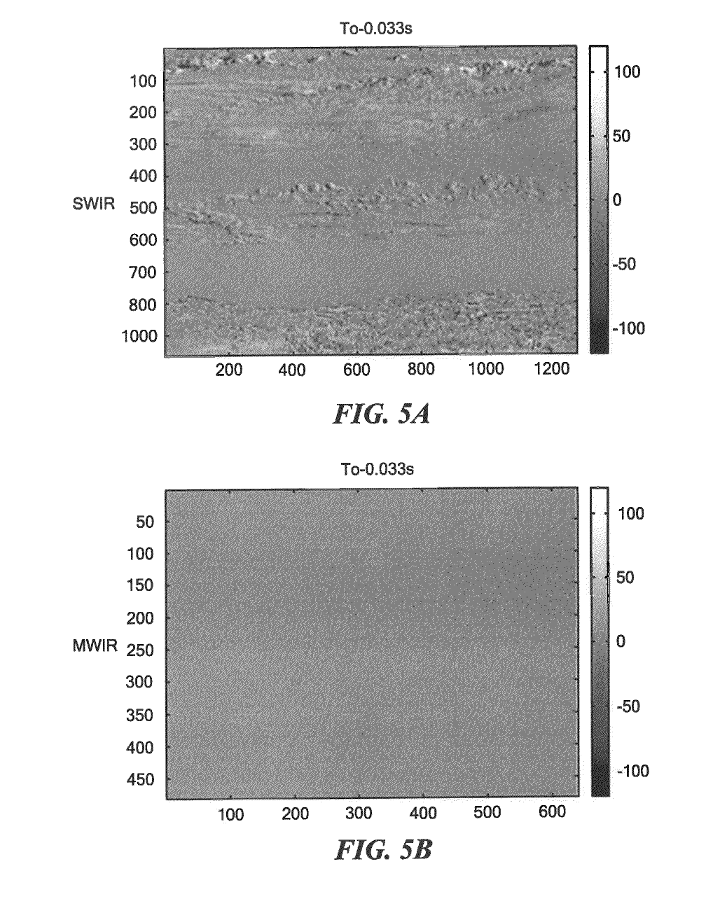

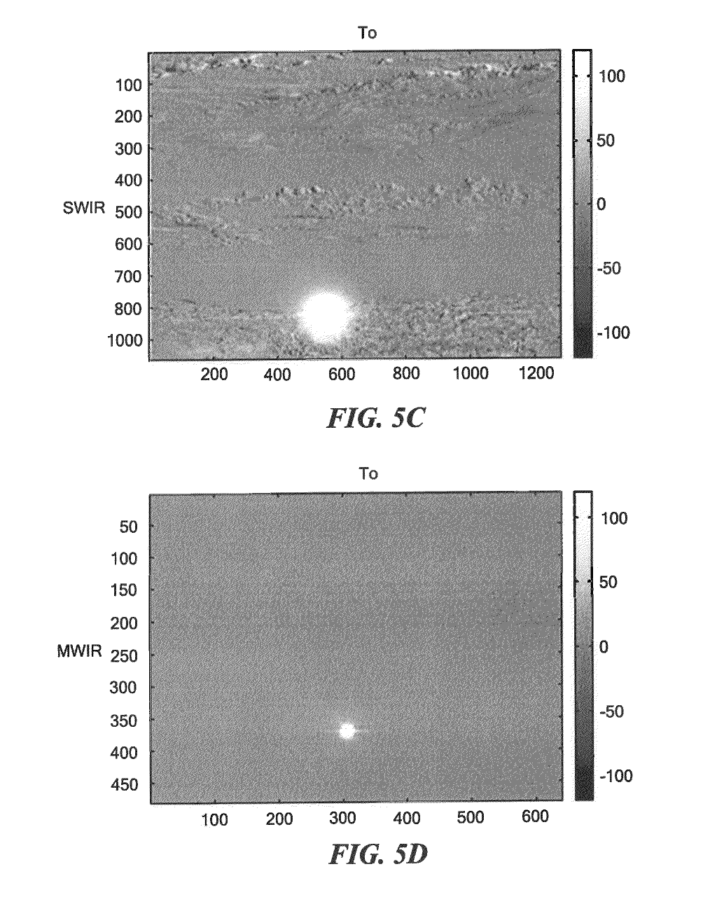

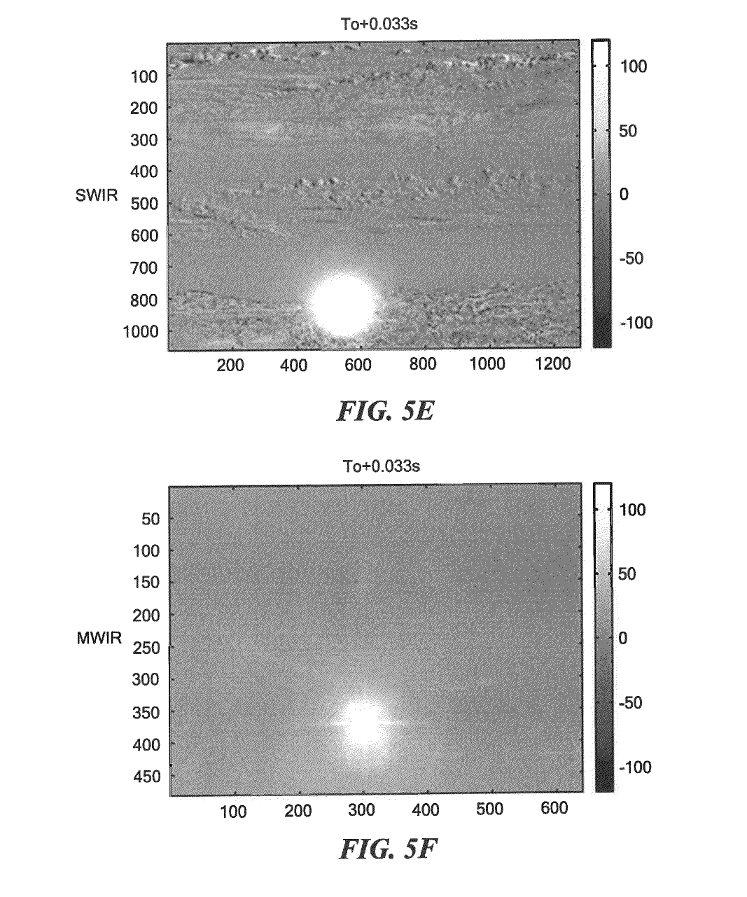

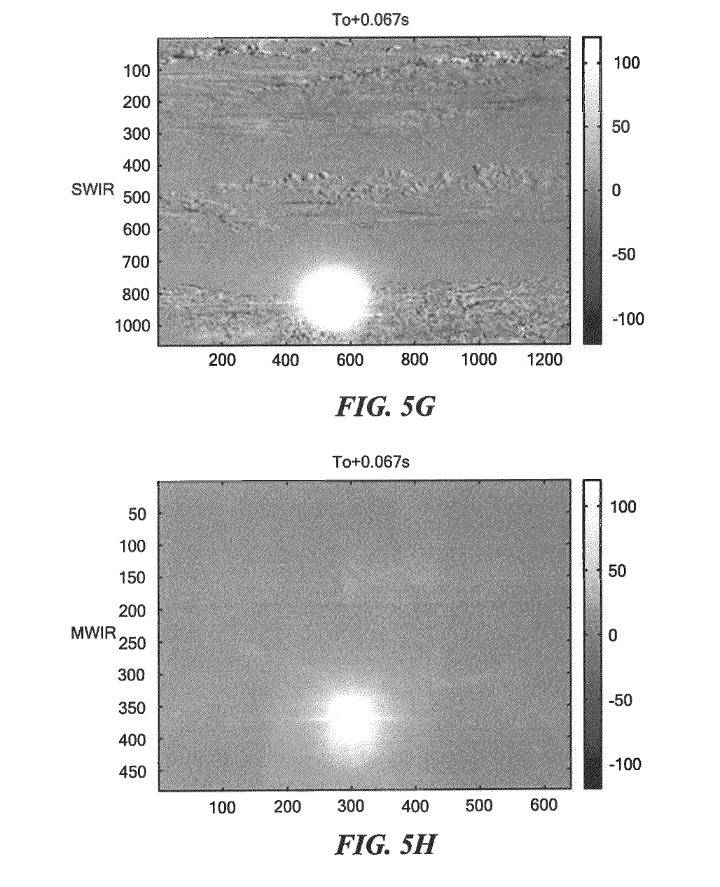

Low energy events likely to cause false alarms with the SWIR sensor will not reach threshold levels in the MWIR/LWIR. Rocket launch events also begin from stationary locations and ignition energy expands spatially around the launch location. This behavior is easily recognized with multi-frame analysis from the pre-ignition frame over several frames. FIG. 5 shows an example of 30 Hz imagery performing multi-frame analysis in both the SWIR and MWIR bands. Multi-frame analysis uses a pre-ignition reference frame from the memory buffer. Image registration or equivalent scene stabilization is used to minimize clutter due to subtracting the reference frame from subsequent frames over time. A Hough transform or equivalent can identify increasing circular radius about the launch origin. At this point, it is not possible to know if the ignition event is a launch or an explosion. However, enough information is available in both bands to send an early warning alert to allow the radar to focus on the potential launch location.

Note the SWIR band needs to run at approximately 200 Hz to meet the ignition time detection requirements. Additionally, the 200 Hz frame rate helps reduce motion related clutter with frame subtraction analysis. The MWIR and LWIR sensors are not as sensitive to motion clutter and are used to confirm SWIR high-energy events so they could be run at approximately 60 to 120 Hz.

Referring again to FIGS. 4A and 4B, after sending the ignition time (or launch time) and location data in an alert, step 428, line-of-sight detection process 400 transitions to Motion Detection mode 403, shown in FIG. 4B.

Multi-frame motion detection analysis, step 430, is similar to ignition expansion detection. Reference frame image registration and/or stabilization algorithms may be used to reduce spatial clutter and a Hough transform or equivalent may be used to identify the circular radius and origin of the high-energy event. When the origin begins to move, as in the case where a rocket moves on the launch rail or a mortar leaves the launch tube, motion detection occurs. The time of target movement is then identified from an embedded GPS time stamp in each frame in the video stream from the sensors in step 434. As noted above, this time stamp may be provided by receiving and incorporating a GPS IRIG B data stream in the sensors' output signals by conventional means.

An alert is then sent to the radar, step 438, with the time of motion. This motion will typically be observed in both SWIR and MWIR/LWIR bands. The time of motion is the essential information that the radar needs to optimize fire finder radar performance with direct fire, low quadrant elevation (QE) threats. In some cases, motion may be detected with non-rocket high-energy detections (such as explosions) with moving objects so ballistic track information, from mode 404, is needed to confirm rocket or mortar launch events.

Although rocket and mortar tracking are described, those skilled in the art will realize other projectiles may be tracked if they are distinguishable from background clutter by their IR emissions or signatures. Accordingly, the concepts, systems, and techniques described herein are not limited to tracking any particular type of projectile.

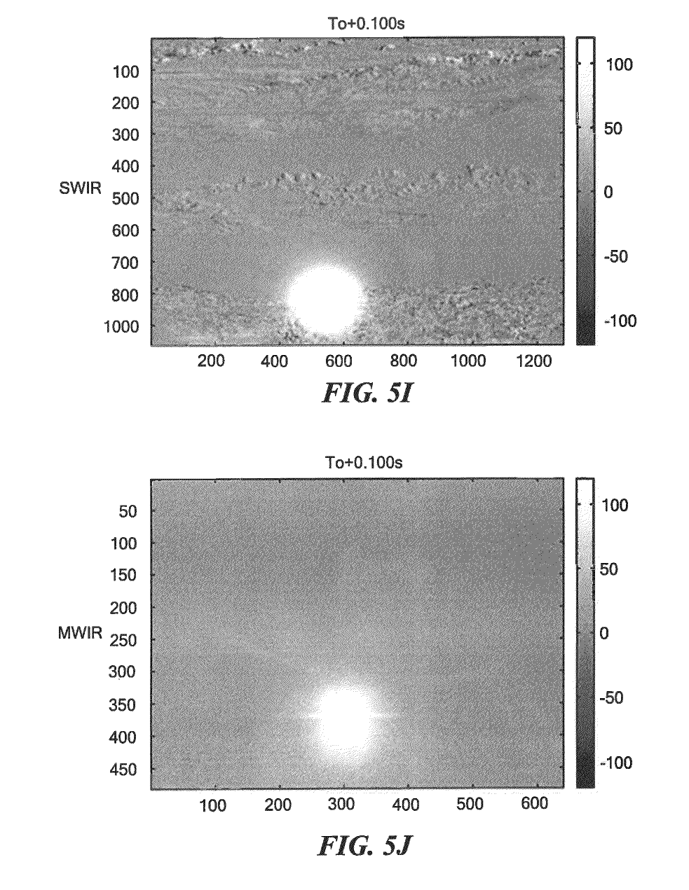

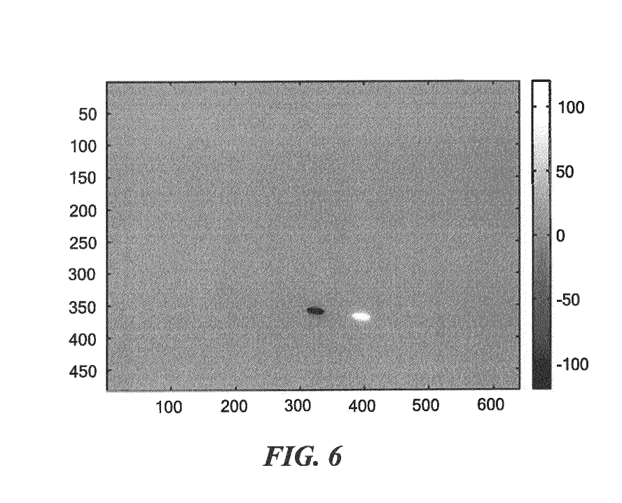

In Ballistic Track mode 404, multi-frame analysis with image registration and/or scene stabilization algorithms and frame-to-frame subtraction may be useful in identifying ballistic targets in flight, steps 440 and 444. FIG. 6 shows a ballistic target in flight with an example of frame-to-frame subtraction with a MWIR imager at 60 Hz. The black spot is the location where the target was and the white is where the target is. Multi-frame analysis can link target position over time and determine track information. This is the final confirmation from ignition detection, motion detection and the ballistic projection confirmation needed and results in a projectile track alert (step 448) and subsequent track updates (step 449) being sent to the radar. The track information provides the highest confirmation of a rocket or mortar launch. The track information combined with the time of projectile motion improves fire finder radar performance.

Direct (line-of-sight) fire detection process 400 then loops indefinitely through connector B to await the next launch event.

FIGS. 7A and 7B show the basic flow for the indirect (non-line-of-sight) fire detection process 700 from ballistic track identification in the MWIR or LWIR band to ignition detection and sending the alert. As for the line-of-sight detection process, each mode will be described in further detail below.

Process 700 begins in Monitor Mode 701, which proceeds as discussed above with respect to FIG. 4A. While the monitor mode is looking for dual band confirmation of high-energy events (as in the direct fire example), it must also look for MWIR motion events consistent with ballistic projectile events. Since frame-to-frame background subtraction is used in this mode (step 418), the system can recognize objects traveling at a high rate of speed in ballistic trajectories.

Once motion is detected in Monitor Mode 701, process 700 transitions to Ballistic Track mode 702. This mode operates in similar fashion to the direct fire case for the MWIR/LWIR bands whenever the monitor mode detects a MWIR target traveling at a rate consistent with a ballistic target. Multi-frame analysis is used to confirm the MWIR/LWIR target and calculate track information, step 724. If a ballistic target is confirmed, an alert containing time and location information is sent to the radar to allow the radar to focus on the target, step 728. Ignition Detection mode 703 is then triggered in the SWIR band to look for an ignition signature.

When Ignition Detection mode 703 is triggered based on a ballistic track confirmation from the MWIR/LWIR or Radar system (steps 720-728), the search is performed in reverse time sequence using the frame buffer in step 730. Image registration and/or scene stabilization algorithms are used to reduce clutter with frame subtraction. Since this is a non-line of sight launch scenario, a broad area must be searched for the ignition source, step 734. Multi-frame subtraction is performed in reverse time order looking for broad area ignition energy near the first location of the ballistic target. A Hough transform or equivalent algorithm may be used to look for radial patterns with semi-circular ignition energy. Processing the frames in reverse order allows the method to follow the energy back an ignition source location. This method may also identify time of motion as well as launch origin location information. An alert with the ignition time and motion detection will then be sent to the radar in step 738.

As in the direct (line-of-sight) fire detection process 400, indirect fire detection process 700 then loops indefinitely through connector B to await the next launch event.

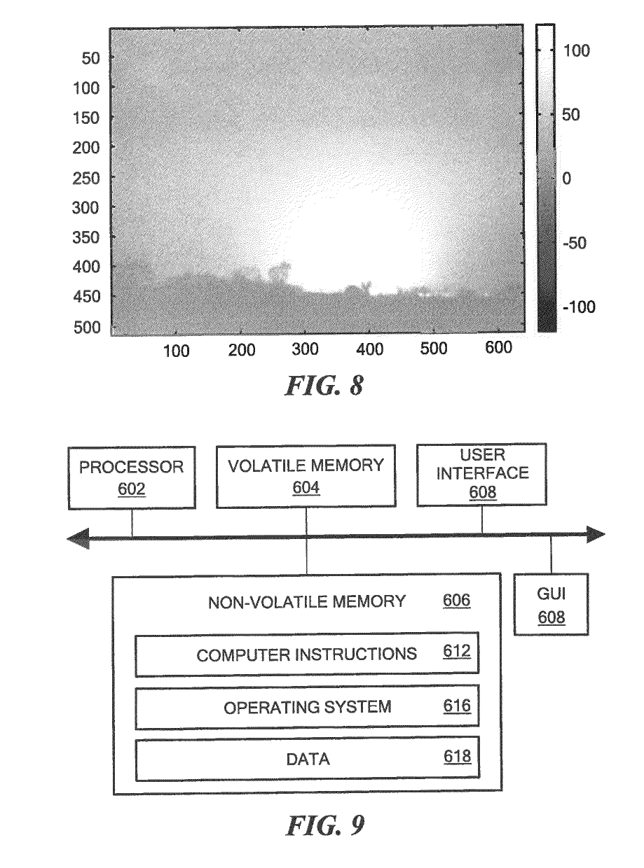

FIG. 8 shows an example of non-line of sight SWIR detection of a launch event. A Hough transform or equivalent of the image would find the origin of the circular ignition energy.

The order in which the steps of the present method are performed is purely illustrative in nature. In fact, the steps can be performed in any order or in parallel, unless otherwise indicated by the present disclosure.

Referring to FIG. 9, a computer may comprise a processor 602, a volatile memory 604, a non-volatile memory 606 (e.g., hard disk), and a graphical user interface (GUI) 608 (e.g., a mouse, a keyboard, a display, for example). The non-volatile memory 606 stores computer instructions 612, an operating system 616 and data specific to the application 618, for example. In one example, the computer instructions 612 are executed by the processor 602 out of volatile memory 604 to perform all or part of the processes described herein.

The processes described herein are not limited to use with the hardware and software of FIG. 9; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each comprises a processor, a storage medium or other article of manufacture that is readable by the processor (including volatile and non-volatile memory and/or storage elements), at least one input device, and one or more output devices. Program code may be applied to data entered using an input device to perform the processes described herein and to generate output information.

The system may be implemented, at least in part, via a computer program product, (e.g., in a machine-readable storage device), for execution by, or to control the operation of data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., DVD, CD-ROM, hard disk, or magnetic diskette) that is readable by a general or special purpose programmable computer for configuring and operating the computer when the storage medium or device is read by the computer to perform the processes described herein. The processes described herein may also be implemented as a machine-readable storage medium, configured with a non-transitory computer program, where upon execution, instructions in the computer program cause the computer to operate in accordance with processes 300 and 550.

The processing blocks associated with implementing the system may be performed by one or more programmable processors executing one or more computer programs to perform the functions of the system. All or part of the system may be implemented as, special purpose logic circuitry (e.g., an field programmable gate array [FPGA] and/or an application-specific integrated circuit [ASIC]).

Elements of different embodiments described herein may be combined to form other embodiments not specifically set forth above. Other embodiments not specifically described herein are also within the scope of the following claims.

While particular embodiments of the present invention have been shown and described, it will be apparent to those skilled in the art that various changes and modifications in form and details may be made therein without departing from the spirit and scope of the invention as defined by the following claims. Accordingly, the appended claims encompass within their scope all such changes and modifications.

We claim:

1. An apparatus, comprising:
a first E/O sensor operating in a first infrared (IR) band having a variable range of sensitivities and an output;
at least a second E/O sensor operating in a second IR band having a variable range of sensitivities and an output;
a processing unit operably connected to said first E/O sensor and said second E/O sensor, said processing unit configured to:
correlate the outputs of said first E/O sensor and the outputs of at least said second E/O sensor,
determine a launch event from said correlation; and
derive time and location information for said launch event from said determination; and
provide said time and location information to the active surveillance radar,
wherein said first E/O sensor and said second E/O sensor are operated at optimum sensitivity to cause target saturation and enable maximum detection range in each said first and second E/O sensors and wherein said second E/O sensor is used at least to confirm the output from said first E/O sensor.

2. The apparatus of claim 1, wherein said first E/O sensor comprises a short-wavelength IR (SWIR) sensor.

3. The apparatus of claim 1, wherein said second E/O sensor comprises a mid-wavelength IR (MWIR) sensor.

4. The apparatus of claim 1, wherein said second E/O sensor comprises a long-wavelength IR (LWIR) sensor.

5. The apparatus of claim 1, wherein said second E/O sensor comprises a MWIR/LWIR sensor.

6. The apparatus of claim 1, further comprising a third E/O sensor having a variable range of sensitivities and operably connected to said processing unit, wherein said third E/O sensor is operated at optimum sensitivity to cause target saturation and enable maximum detection range.

7. An apparatus, comprising:
a first E/O sensor operating in a first infrared (IR) band having a variable range of sensitivities;
at least a second E/O sensor operating in a second IR band having a variable range of sensitivities;
a processing unit operably connected to said first E/O sensor and said second E/O sensor, said processing unit configured to:
correlate the outputs of said first E/O sensor and the outputs of at least said second E/O sensor;
determine a non-line of sight launch event from said correlation; and
derive time and location information for said launch event from said determination; and
provide said time and location information to the radar,
wherein said first E/O sensor and said second E/O sensor are operated at optimum sensitivity to cause target saturation and enable maximum detection range in each said E/O sensor.

8. The apparatus of claim 7, wherein said first E/O sensor comprises a short-wavelength IR (SWIR) sensor.

9. The apparatus of claim 7, wherein said second E/O sensor comprises a mid-wavelength IR (MWIR) sensor.

10. The apparatus of claim 7, wherein said second E/O sensor comprises a long-wavelength IR (LWIR) sensor.

11. The apparatus of claim 7, wherein said second E/O sensor comprises a MWIR/LWIR sensor.

12. The apparatus of claim 7, further comprising a third E/O sensor having a variable range of sensitivities and operably connected to said processing unit, wherein said third E/O sensor is operated at optimum sensitivity to cause target saturation and enable maximum detection range.

13. A method, comprising:
continuously monitoring a user-selected region for a launch event by performing frame-to-frame background subtraction on images from a plurality of E/O sensors, wherein said E/O sensors are operated at optimum sensitivity to cause target saturation and enable maximum detection range in said images;
on detecting said launch event:
confirming said launch event by correlating said images from at least two of said plurality of E/O sensors;
performing multi-frame signature recognition on said images to detect an ignition; and
providing an alert to a radar based on said signature recognition.

14. The method of claim 13, further comprising the step of detecting target motion with multi-frame analysis.

15. The method of claim 14, further comprising the step of identifying time of target movement from said images.

16. The method of claim 15, further comprising the step of tracking said target using a multi-frame tracking algorithm based on said images.

17. An apparatus, comprising:
means for continuously monitoring a user-selected region for a launch event by performing frame-to-frame background subtraction on images from a plurality of E/O sensors, wherein said E/O sensors are operated at optimum sensitivity to cause target saturation and enable maximum detection range in said images;
on detecting said launch event:
means for confirming said launch event by correlating said images from at least two of said plurality of E/O sensors;
means for performing multi-frame signature recognition on said images to detect an ignition; and
means for providing an alert to a radar based on said signature recognition.

18. The apparatus of claim 17, further comprising means for detecting target motion with multi-frame analysis.

19. The apparatus of claim 18, further comprising means for identifying time of target movement from said images.

20. The apparatus of claim 19, further comprising means for tracking said target using a multi-frame tracking algorithm based on said images.
